(19) United States
(12) Patent Application Publication
(10) Pub. No.: US 2023/0289872 A1
(43) Pub. Date: Sep. 14, 2023

(54) SYSTEM AND METHOD FOR PRICE DISCOVERY AND PRICE IMPROVEMENT AMID COMBINATORIAL SPECIFICATIONS

(71) Applicant: MMG TECHNOLOGIES, INC., Jackson, WY (US)

(72) Inventors: Hans J. Dau, Jackson, WY (US); Philip Miller Gillespie, Flushing, NY (US)

(21) Appl. No.: 18/119,222

(22) Filed: Mar. 8, 2023

Related U.S. Application Data
(60) Provisional application No. 63/318,724, filed on Mar. 10, 2022.

(51) Int. Cl. G06Q 30/08; G06Q 30/0201

(52) U.S. Cl. CPC G06Q 30/08; G06Q 30/0206

(57) ABSTRACT

Method of price discovery includes: creating a bid design file as a set of specification variables, pricing variables, bid evaluation scenarios, and bid evaluation formulas; producing a scenario file as a set of observations; producing a specification variable matrix including the bid scenario for each observation and item; producing a bid template including producing a data structure as a bid template including the pricing variables, bid evaluation formulas, and the specification variable matrix; transmitting the bid template to the bidding suppliers; receiving completed bids; computing price savings attributable to each item across all bidding suppliers; producing a bid evaluation matrix including bid prices for each bidder for each item from the specification variables and computed price savings attributable to each item across all bidding suppliers; and displaying contents of the bid evaluation matrix to a buyer, as the price discovery for the plurality of bidding suppliers and items.

### CROSS-REFERENCE TO RELATED APPLICATIONS

This Patent application claims the benefits of U.S. Provisional Patent Application Ser. No. 63/318,724, filed on Mar. 10, 2022 and entitled “System and Method for Price Discovery and Price Improvement Amid Combinatorial Specifications,” the entire content of which is hereby expressly incorporated by reference.

### FIELD

The present disclosure generally relates to computer software and data structures and more specifically to computer software and data structures for price discovery.

### BACKGROUND

A combinatorial explosion is the rapid growth of the complexity of a problem due to how the combinatorics of the problem are affected by the input, constraints, and bounds of the problem. Combinatorial explosion is sometimes used to justify the intractability of certain problems. Examples of such problems include certain mathematical functions, the analysis of some puzzles and games, and some pathological examples.

In some conventional approaches for static combinatorial bidding, there is a direct relationship between the design of the bidding event and the number of prices generated by the design. Conceptually, the design of a bidding event and the number of prices generated by that design are two sides of the same coin. Therefore, the focus of the conventional solution approaches has been methods for pruning the potentially vast number of prices generated by complex bid event designs that suffer from combinatorial explosion.

There are also bidding processes, which describe tweaks to the rules of the bidding event that prevent certain undesirable outcomes among the prices supplied by the bidders. These conventional methods all leave the fundamental nature of how to fully address a pricing domain that exhibits a combinatorial explosion in the specification itself as an unsolved problem in the field.

Moreover, another critical aspect of the conventional approaches is that the specification for the item or set of items that is the object of the bidding needs to be known at the time of the bid with a high degree of certainty. These conventional approaches handle discrete objects with known specifications that are priced individually or as sets of discrete objects, each with known specifications, which are priced together as a lot. Expressed mathematically, prices are expressed discretely in the form of (S, b), where S is an item or set of items and b is the bid price for an item or set of items.

All of the existing bidding tools are built around this same (S,b) data model, a model that we will refer to as the “Catalog Item Model”. In the Catalog Item Model, the buyer must provide a specification for the item and a quantity of items to be purchased (the “S” in the notation). The suppliers participating in the bidding event provide the prices (the “b” in the notation). In the most basic case, the most atomic unit is a one-item bidding event. There are two variations on the basic theme: (1) the buyer might have a set of items which are priced as a lot, and (2) the bidding event might be an auction and not a sealed bid industrial procurement bid submission. It is important to note that the existing tools cannot handle bidding events other than these two variations of Catalog Item Model bidding events.

Moreover, the tools using the conventional approaches work within the paradigm of a bidding event consisting of known items with known specifications and known quantities. Often these tools also have a requisition composition facility which enumerates the line items, descriptions, and quantities in the form of the familiar procurement requisition which is well known to all the procurement tools in the conventional methods. The working hypothesis of the tools in the conventional methods is that the objective of the buyer is to conduct a bidding event around the known items with known specifications for known quantities, select a winner or set of winners, and then convert the award decision(s) into a purchase order(s) in a timely fashion.

However, conventional tools do not handle cases where the buyer is not in possession of detailed item specifications and quantities at the time of the bidding event. There are many cases that arise in goods and services procurement where spending is very high year-on-year, but specification commonality year-on-year is low or nil. The present disclosure addresses these situations.

Furthermore, the corollary of the scope deficiencies of the conventional tools is that a buyer is forced to allocate tremendous time to using the tools that do exist. In the conventional methods, the buyer must wait until there is enough clarity in the order book and production plan so that a list of items with known specifications and known quantities can be produced before a bidding event can take place. As the order book and production plan are often continually changing, the buyer using the tools of the conventional methods is constrained by those tools to be continually running bidding events.

The present approach is a significant departure from this prevailing model by disclosing a novel price discovery data model and methods for handling the difficult cases that are not well suited to the existing tools and methods.

### SUMMARY

In some embodiments, the present disclosure is directed to a software process and unique data structures for price discovery and improvement through computerized bidding events, such as sealed bid industrial procurement tenders, auctions, and combinatorial auctions. The method is executed by one or more processors, such as servers, desktop computers, laptop computers, and the like.

In some embodiments, the present disclosure is a computer-implemented method of price discovery during a bidding event conducted between a buyer and a plurality of bidding suppliers by creating a bid design file as a set of specification variables, pricing variables, one or more bid evaluation scenarios, and one or more bid evaluation formulas; producing a scenario file as a set of observations based on historical transactions or projection of future demand or items related to the bidding suppliers or the price bidding event and respective weightings of each observation; producing a data structure as a specification variable matrix including the bid scenario for each observation and item; producing a data structure as a bid template including the pricing variables, bid evaluation formulas, and the specification variable matrix; transmitting, over a computer network, the bid template to the bidding suppliers; receiving, over the computer network, a plurality of completed bids from the bidding suppliers; and computing price savings attributable to each item across all bidding suppliers. The method further includes producing a data structure as a bid evaluation matrix including the computation of item bid prices for each bidder and for each item using the specification variables, and computed price savings attributable to each item across all bidding suppliers. The bid evaluation matrix carries forward the item name and weightings and historical prices paid for each of the observations from the specification variable matrix, and the bid evaluation matrix further includes information about bidding suppliers, from the pricing variable matrix; and displaying, on a display screen, contents of the pricing variable matrix and bid evaluation matrix to a buyer, as the price discovery results for the plurality of bidding suppliers and items.

### BRIEF DESCRIPTION OF THE DRAWINGS

A more complete appreciation of the present disclosure and many of the attendant features and aspects thereof, will become more readily apparent as the disclosure becomes better understood by reference to the following detailed description when considered in conjunction with the accompanying drawings in which like reference symbols indicate like components.

FIG. 1 illustrates an exemplary process flow for price discovery during a price bidding event by a plurality of bidding suppliers, according to some embodiments of the disclosure.

FIG. 2 illustrates a variable matrix, a data structure for storing the variables used in the price discovery process, according to some embodiments of the disclosure.

FIG. 3 illustrates a specification variable matrix, a data structure for storing the attributes of the specification variables used in the price discovery process, according to some embodiments of the disclosure.

FIG. 4 illustrates a pricing variable matrix, a data structure for storing the attributes of the pricing variables used in the price discovery process, according to some embodiments of the disclosure.

FIG. 5 illustrates a bid evaluation matrix, a data structure for storing results from bidding events conducted using the price discovery process, according to some embodiments of the disclosure.

FIG. 6 illustrates a target pricing matrix, a data structure for storing target pricing results to implement the pricing improvement process, according to some embodiments of the disclosure.

FIG. 7 illustrates an exemplary process flow for price discovery and price improvement, according to some embodiments of the disclosure.

FIG. 8 shows an exemplary process for creating a bid design, including a bid evaluation formula set and defining variables, according to some embodiments of the disclosure.

FIG. 9 depicts an exemplary process flow for populating a specification variable matrix, according to some embodiments of the disclosure.

FIG. 10 illustrates an exemplary process flow for collecting bids, according to some embodiments of the disclosure.

FIG. 11 shows an exemplary process flow for a bid evaluation, according to some embodiments of the disclosure.

FIG. 12 depicts an exemplary process flow for price improvement, according to some embodiments of the disclosure.

FIG. 13 illustrates an exemplary contractual formula set, a data structure that stores the formulas that have been contractually agreed to between a buyer and a supplier, according to some embodiments of the disclosure.

FIG. 14 illustrates an exemplary contractual variable matrix, a data structure that defines the variables that are used in a pricing vector quoting machine, according to some embodiments of the disclosure.

FIG. 15 illustrates an exemplary contractual pricing variable matrix, a data structure for storing the supplier-specific pricing variables that a buyer and a supplier have agreed to, according to some embodiments of the disclosure.

FIG. 16 illustrates an exemplary item variables matrix, a data structure that stores the specifications for individual items to be priced by the pricing vector quoting machine, according to some embodiments of the disclosure.

FIG. 17 illustrates an exemplary item pricing matrix, a data structure that stores the pricing by supplier for a set of defined items, according to some embodiments of the disclosure.

FIG. 18 illustrates an exemplary process for a pricing vector quoting machine, according to some embodiments of the disclosure.

### DETAIL DESCRIPTION

In some embodiments, the system and method of the present disclosure converts a procurement domain that suffers from a combinatorial explosion in the number of individual item specifications (a domain that has “combinatorial specifications”) into a domain, represented by various novel data structures, that is both finite and computable. In this context, “finite” means the number of individual prices collected during the bidding event does not require participants to supply an impractical quantity of information during the event itself. “Computable” means that the pricing information collected during the bidding event is collected in a format that allows for individual prices to be determined using a deterministic algorithm that runs in polynomial time.

Using this approach, the data collection requirements for a bidding event for a procurement domain having combinatorial specifications can be transformed from enumerating the specifications and collecting prices for a “completely impractical” number of items into a bid data structure that revolves around a relatively small number of parameters, coefficients, and variables and a modest set of deterministic, polynomial-time formulas.

### Example: PVC Pipes

Consider a buyer who requires PVC pipes in various lengths, inner and outer diameters, colors, and imprinted with various letters and logos. The sourcing and procurement situation faced by this buyer is more complicated than it appears, because some of the specifications have an infinite number of possibilities. Even if the buyer had a full and complete knowledge of the historical procurement pattern for PVC pipes at their company, such knowledge would often be useless in forecasting the future demand at the level of specificity needed to source that demand in aggregate. That is, a buyer often knows that their company's aggregate spending on a category of items, such as PVC pipes, could total hundreds of thousands of dollars per quarter of a calendar year. However, close inspection of those historical orders over time often does not show much commonality of specifications from quarter to quarter.

After conducting such a historical analysis that reveals shifting specifications over time, the buyer realizes that composing a bid using the conventional methods that attempt to cover all of the shifting specifications over time would result in a totally impractical number of items to be defined in the bid. Such a buyer is said to face a procurement category of spend with a combinatorial specification explosion for the items in the category. This is particularly true for any bidding event that involves a specification, like PVC pipe length in this example, which contains a real-valued function. By definition, there exist an infinite number of possible numerical values for any one real-valued function, and buyers often face the challenge that the sourcing domain contains multiple real-valued specifications. In the case of PVC pipes, the inner and outer diameters of the pipes are also real-valued functions with an infinite number of possible combinations.

A buyer facing a category of spend with a combinatorial specification explosion will find that the conventional tools and approaches are deficient. The conventional tools require that both specification and volume be known at the time the order is placed or they do not function. The best that a buyer working with conventional tools can do in this situation is to place orders only as the complete specifications and the exact quantities needed become apparent.

The present disclosure lifts the constraints facing this buyer, and thus it becomes possible to separate the pricing of the items suffering combinatorial specification explosion from the order placement activity for those same items. Buyers can then aggregate their spending via, e.g., an annual bidding event, and then place orders throughout the rest of the year with the suppliers who provided the most attractive offers during the bidding event. Importantly, the buyer can present their full demand set to the marketplace at one time and then use that volume leverage to secure the most advantageous pricing possible during a single bidding event, something that would be impossible to do working with the conventional tools.

The system and method of the present disclosure provide buyers with a superior alternative, one that allows the buyers to describe their entire demand set, present that demand set to the market in an aggregated fashion, and then secure the most attractive pricing possible for that demand set. The system and method of the present disclosure also dramatically reduce the number of times the buyer will have to conduct bidding events, which is a tremendous savings of staff time.

From the supplier perspective, the decision logic that causes a supplier to choose to participate in a buyer's bidding event changes if the buyer employs the approach of the present disclosure. According to the present disclosure, numerous, small, limited-scope bidding events are replaced by a single bidding event covering perhaps a year's worth of demand from the buyer. The supplier choosing not to participate in this higher-stakes bidding event may not have another opportunity to bid on that buyer's volume for a year. By using novel data structures of the present disclosure, buyers can collect pricing that applies to their aggregated demand. As a result, buyers using the data structures and methods of the present disclosure maximize the value of their spending in the marketplace to secure the most advantageous pricing possible.

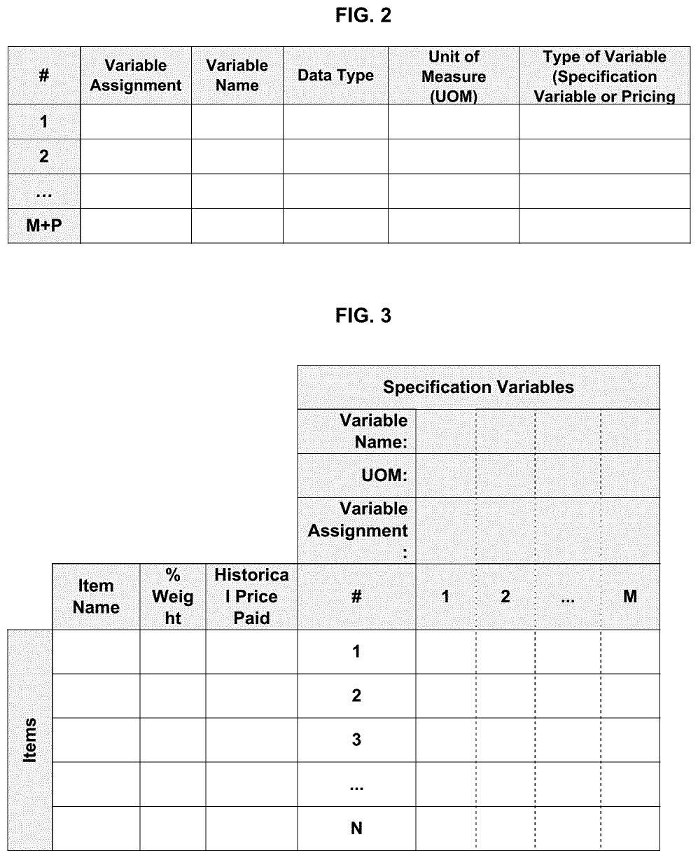

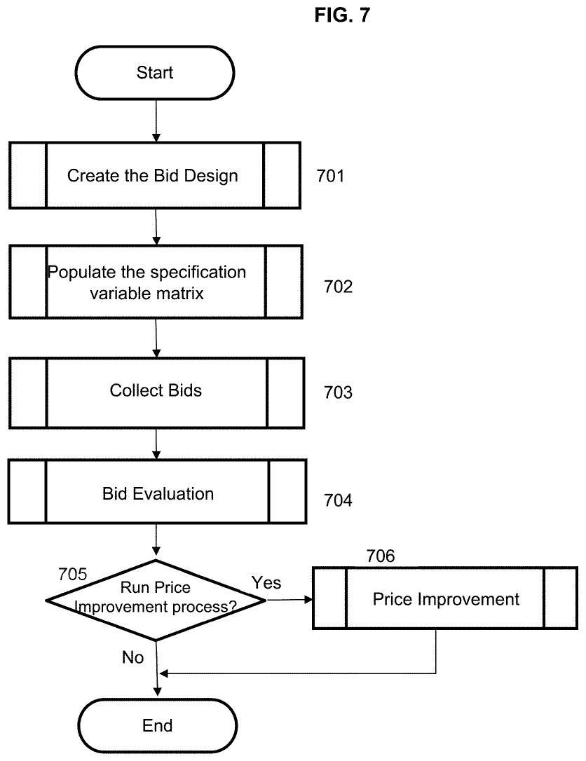

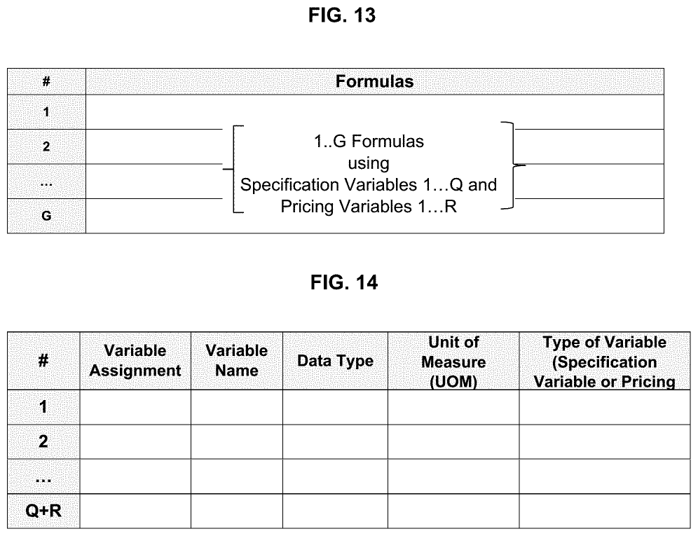

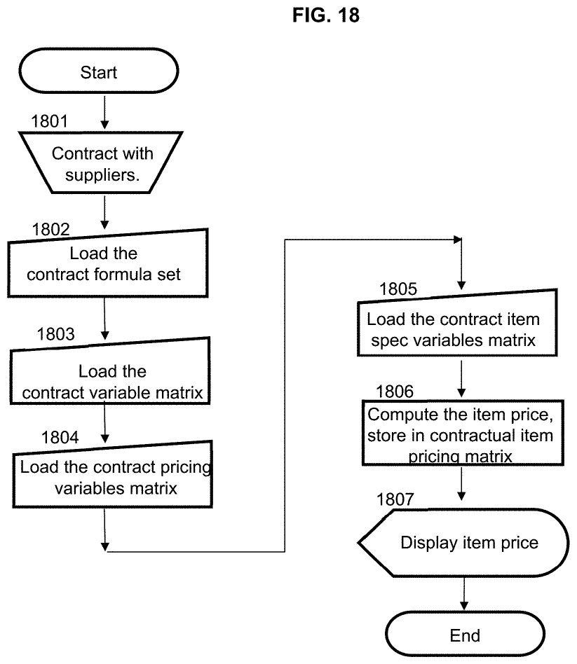

The disclosure includes four groups of Figures: FIGS. 2 through 6 describe examples of unique data structures for the price discovery and improvement process; FIGS. 7 through 12 describe examples of price discovery and improvement methods; FIGS. 13 through 17 describe examples of data structures for the pricing vector quoting machine; and FIG. 18 describes an example of the method used by the pricing vector quoting machine.

In some embodiments, the pricing vector quoting machine (PVQM) is a processing circuit that takes as an input the specification for an item that the machine was designed to price and produces as an output a set of pre-contracted prices from a known vendor set. Note that the machine (processor) does this without conducting a bidding process. Consider the case of PVC pipes: the buyer inputs the specification for the particular PVC pipe of interest, and the machine returns the prices for that specification from all of the PVC pipe suppliers that have been previously defined to the machine. A buyer with a PVQM would be able to determine, for example, which supplier they should go to for placing that PVC pipe order with an unusual combination of inner and outer pipe diameters. In this way, the sourcing problem for an infinitely variable domain is reduced from “bid the job every time to figure out which supplier to use” to a “plug-and-chug” problem which the processing circuit can do in the blink of an eye. The term “processing circuit” as used here includes any combination of hardware, firmware, and software, employed to process data and information, such as a computer, mobile device, or any processor with associated circuitry.

In some embodiments, the system applies a bid evaluation formula set, a data structure for capturing the 1-F formulas using 1-M specification variables and 1-P pricing variables to compute and store the system-calculated supplier bid price for an item in a bid evaluation matrix (described below), where F is the number of Formulas to be used, M is the number of specification variables and P is the number of pricing variables. Note that there is no limit to the number of formulas that this data structure might contain.

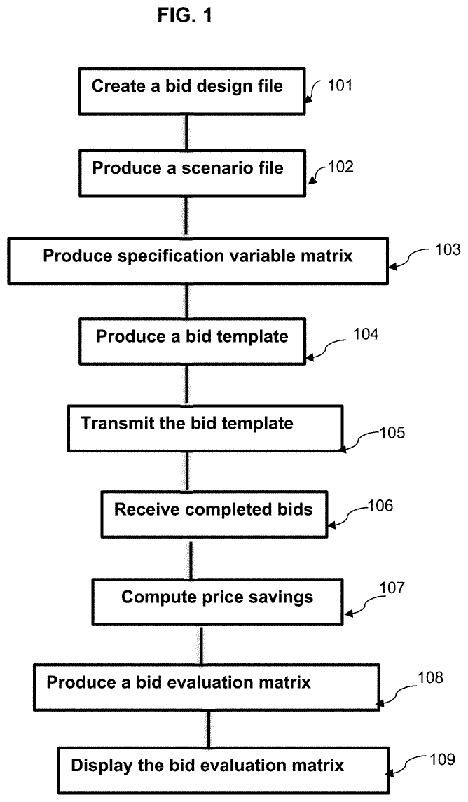

FIG. 1 illustrates an exemplary process flow for price discovery during a price bidding event by a plurality of bidding suppliers, according to some embodiments of the disclosure. As shown in block 101, a bid design file is created as a set of specification variables, pricing variables, one or more bid evaluation scenarios, and one or more bid evaluation formulas. In block 102, a scenario file is produced as a set of observations including historical transactions or a projection of future demand for items within the scope of the bid, or a set of benchmark pricing levels available to the buyer, and respective weightings for each item. A data structure is produced as a specification variable matrix including the bid scenario for each observation and item, in block 103. A data structure is produced as a bid template including the pricing variables, the bid evaluation formulas, and the specification variable matrix (having first redacted any historical or benchmark pricing information from the specification variable matrix), in block 104. The bid template is transmitted (over a computer network) to each of the bidding suppliers, in block 105. In block 106, a plurality of completed bids are received from the bidding suppliers (over the computer network).

In block 107, price savings attributable to each item across all bidding suppliers are computed. In block 108, a data structure is produced as a bid evaluation matrix including the computed item prices for each bidder across each item in the specification variable matrix and the computed price savings attributable to each item across all bidding suppliers. In some embodiments, computing price savings attributable utilizes pricing variables submitted by the bidding suppliers, the specifications and bid evaluation formulas in the bid template. The bid evaluation matrix carries forward the weightings and historical or benchmark prices paid for each of the observations from the specification variable matrix and further includes item name, percentage weight, historical or benchmark price paid, variable names and information about bidding suppliers, including computed item bid prices and savings associated with each of the bidding suppliers. In block 109, the contents of the pricing variable matrix and bid evaluation matrix are displayed (on a display screen) to a buyer, as the price discovery results for the plurality of bidding suppliers and items. A more detailed description of each block is provided below.

FIG. 2 shows a variables matrix, a data structure for capturing the essential variable relationships, for example, the variable assignment, variable name, data type, unit of measure, and type of variable (specification variable or pricing variable). Note that there is no limit to the number of variables that this data structure might contain.

FIG. 3 illustrates a specification variable matrix, a data structure for capturing 1-M specification variables for 1-N items, according to some embodiments of the disclosure. The items N may be historical items, future items, i.e., pro-forma items for which the buyer is seeking pricing, or benchmark items. The terms “items”, “observations”, “transactions” or “jobs” are often used to refer to items and may be used interchangeably in the present disclosure. For each specification variable, the variable matrix data structure described above in FIG. 2 includes the variable name, the unit of measure (“UOM”), and the variable assignment. The variable assignment is the variable letter assignment for a specific variable name in one of the formulas. For each item, the specification variable matrix data structure also includes the weight for each item (or some items) and, if available, the historical or benchmark price paid for the item. In some embodiments, the values for the weights are based on the historical spending on the item in relation to the total spending in the category. However, the buyer can choose to set the weights to a figure representing the proportion of spend represented by that item in a pro-forma production plan. Note also that the buyer may choose to equally weight each observation, and in that case the weighting for each item would be 1/N (e.g., in the case of 12 observations, each item weight would be 1/12 or 0.0833 or 8.33%).

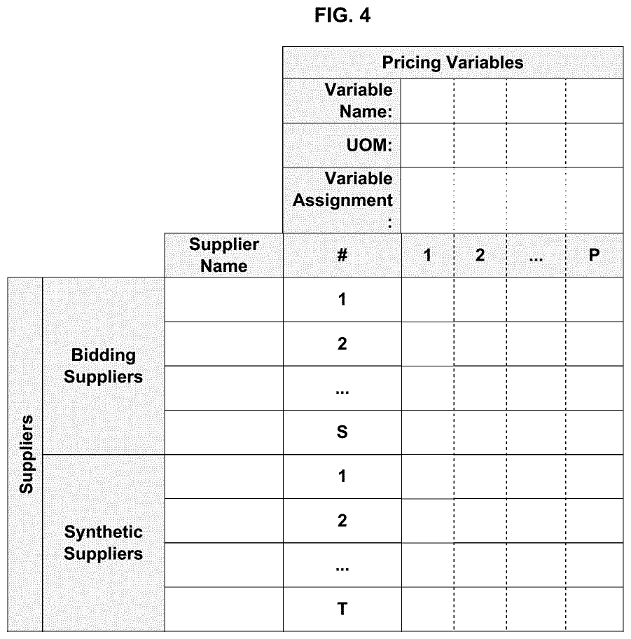

FIG. 4 illustrates the pricing variable matrix, a data structure for capturing the coefficients for 1-P pricing variables for 1-S bidding suppliers and 1-T synthetic suppliers, according to some embodiments of the disclosure. S is the number of bidding suppliers and T is the number of synthetic suppliers. For each pricing variable, the matrix captures the variable name, the unit of measure (“UOM”), and a variable assignment. The variable assignment is used to connect a specific variable name with a letter assignment in one of the formulas. For each supplier, the matrix captures the supplier's name. Synthetic suppliers are suppliers computed by the system that represent acceptable (useful) benchmark pricing levels. An example of a synthetic supplier would be the “synthetic minimum” supplier, which is a computed bid comprising of the set of the lowest coefficients for each pricing variable across all of the suppliers participating in a bid. The pricing variable matrix data structure is designed to accommodate any number of bidding suppliers and any number of synthetic suppliers.

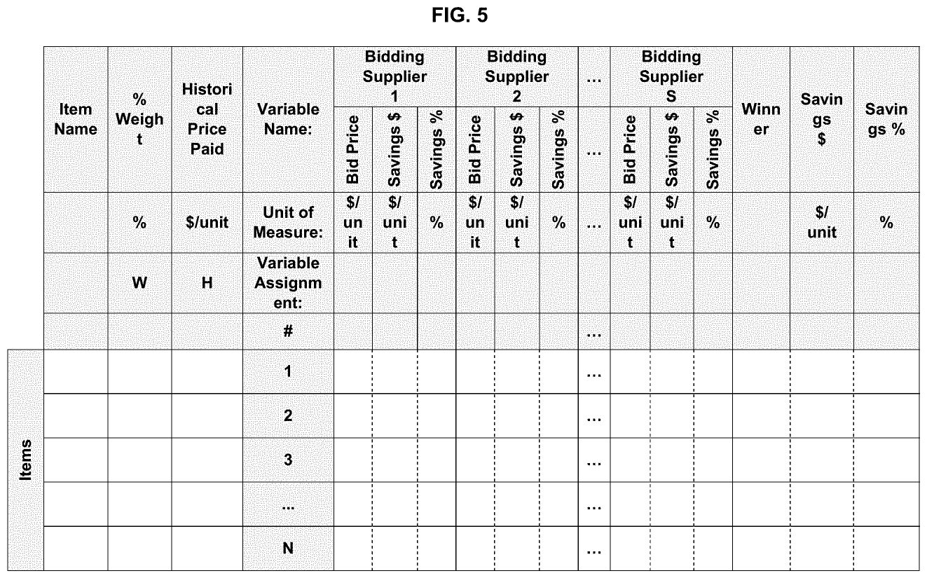

FIG. 5 illustrates a bid evaluation matrix, a data structure for storing the computed bid prices for 1-S bidding suppliers for each of the 1-N items in the specification variables matrix, according to some embodiments of the disclosure. To make subsequent calculations easy, this data structure carries forward the weightings and historical or benchmark prices paid for each of the observations from the specification variable matrix. As shown, the bid evaluation matrix includes item name, percentage weight, historical or benchmark price paid, variable name, and information about bidding suppliers, including the calculated item prices and savings. In some embodiments, the individual item prices in the bid evaluation matrix are derived from a computation that uses the pricing variables submitted by each supplier in combination with the specifications and formulas in the bid design. Although the bid design contains individual items, those items are provided to the supplier so that the supplier can calibrate the pricing variables that are the core of their bid response. The supplier does not return prices tied to individual items (as would be the case in the tools and methods known in the art).

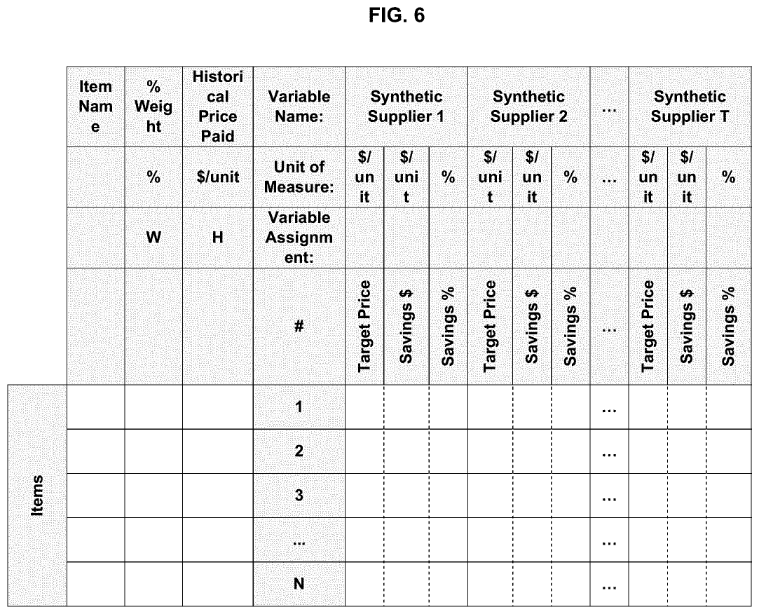

FIG. 6 illustrates a target pricing matrix, a data structure for capturing computed item prices for 1-T synthetic suppliers for each of the 1-N items in the specification variables matrix, according to some embodiments of the disclosure. This data structure is similar to the bid evaluation matrix shown in FIG. 5. To make subsequent calculations easy, this data structure carries forward the weightings and historical or benchmark prices paid for each of the observations from the specification variable matrix.

FIG. 7 illustrates an exemplary top-level process flow for price discovery and improvement, according to some embodiments of the disclosure. Typically, the people interacting with the system are buyers, people seeking to fulfill procurement needs, and the suppliers who furnish information through the system back to the buyer in response to that need. As known in the art, each of these people interact with one or more computing devices, such as personal computers, laptops, electronic pads, smart phones, and/or other personal digital assistants (PDAs). The computing stations/devices are capable of communicating with each other via a computer network, such as the Internet. The processes in FIGS. 7 to 12 and 18 are executed by one or more of the above-mentioned computing devices and information among the various computing devices is stored in various storage devices and shared via the computer networks.

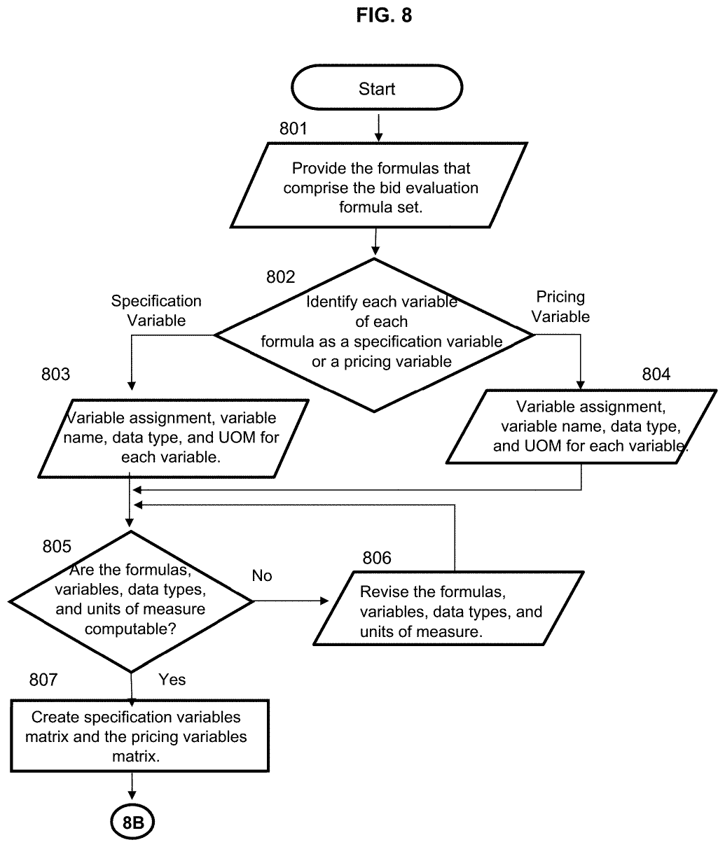

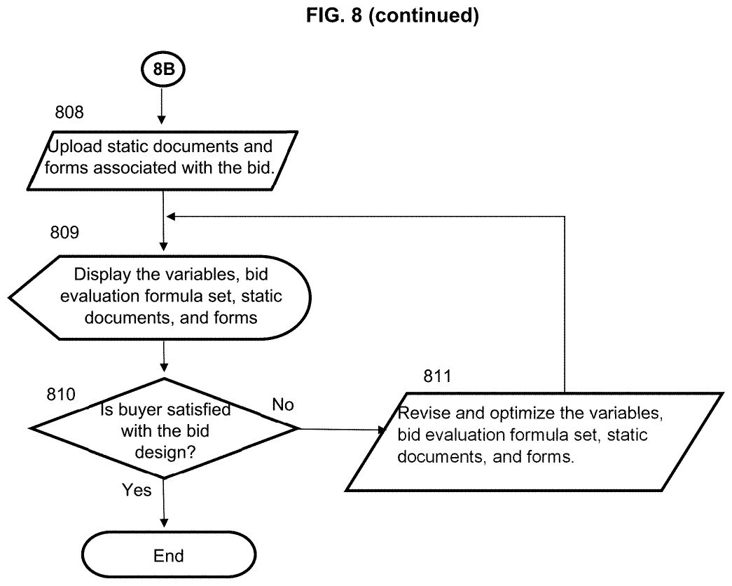

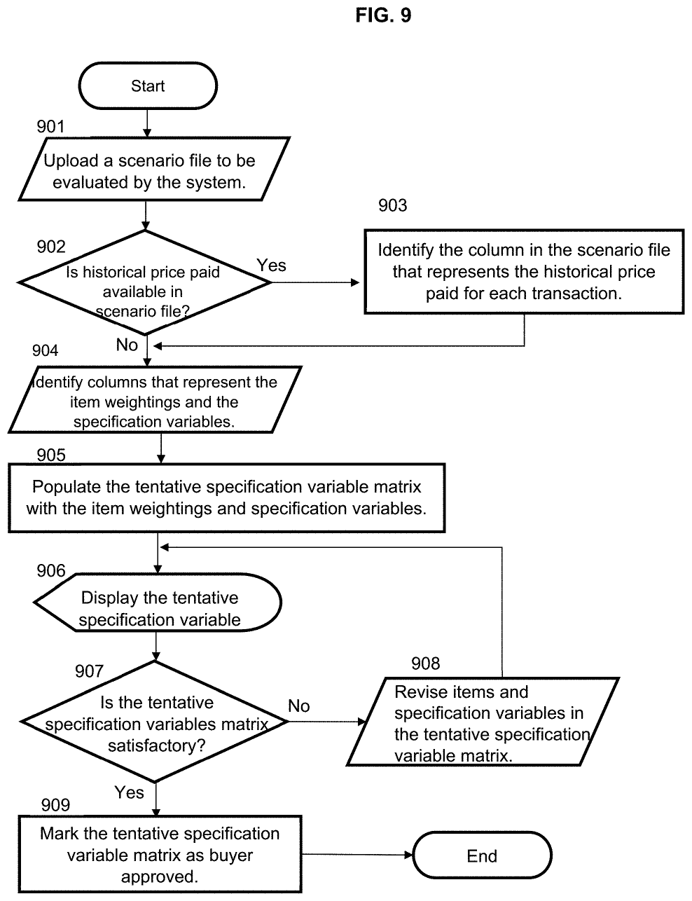

As shown in block 701 of FIG. 7, the system executes a process to create a bid design, which includes the set of formulas that collectively describe how a price will be determined for the purposes of the bid (the “bid evaluation formula set”), the variables that will be used in the formulas, and two of the data structures that will be needed in the subsequent processes. A more detailed description of block 701 is provided below with respect to FIG. 8. In block 702, the system executes a process to populate the specification variable matrix, which is a unique data structure. A more detailed description of block 702 is provided below with respect to FIG. 9.

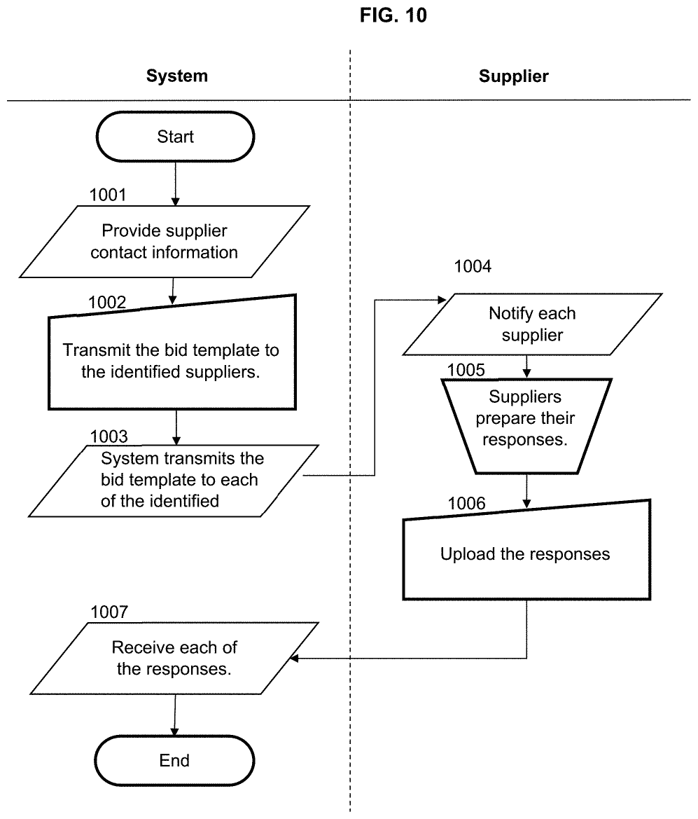

In block 703, the system executes a process to collect bids from the suppliers, including defining the suppliers to the system, transmitting the set of information comprising the bid (the “bid template”) over a computer network to the supplier(s). A more detailed description of block 703 is provided below with respect to FIG. 10.

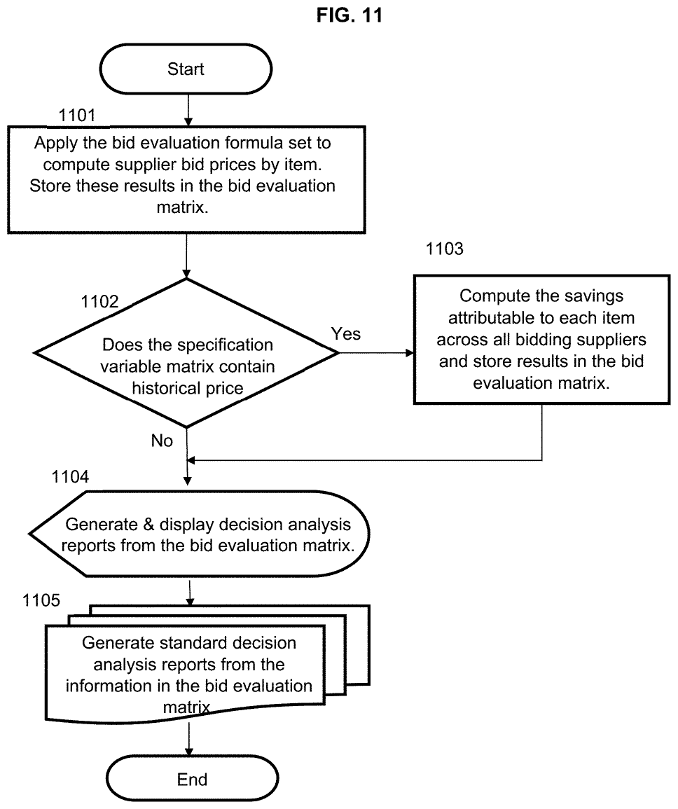

In block 704, the system executes a process to evaluate the bids collected from the suppliers. For each supplier bid and for each item in the specification variable matrix, the system applies the bid evaluation formula set and computes and stores the system-calculated supplier bid price for that item in the bid evaluation matrix. A more detailed description of block 704 is provided below with respect to FIG. 11.

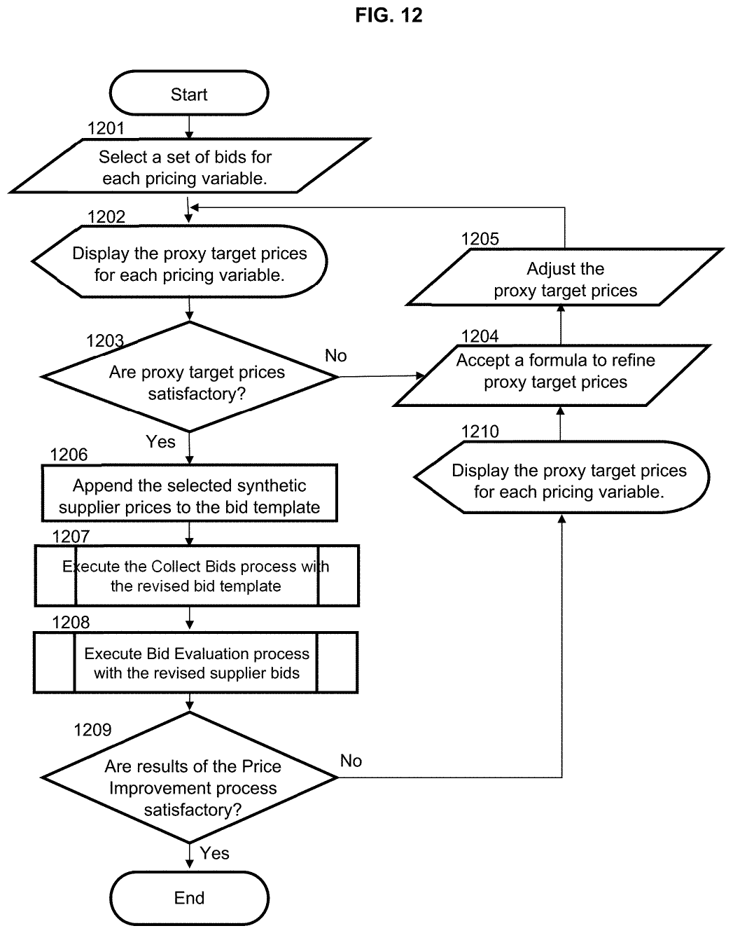

In block 705, the system queries the buyer whether to run the price improvement process. If the buyer signals in the affirmative, the system executes a price improvement process that uses pricing variables collected from the suppliers to set proxy target prices and stores them in the target pricing matrix. The system uses the information in the target pricing matrix to drive a process which encourages suppliers to submit lower prices in subsequent bidding rounds, in block 706. A more detailed description of block 706 is provided below with respect to FIG. 12.

FIG. 8 depicts an exemplary process for collecting a bid evaluation formula set and defining variables, according to some embodiments of the disclosure. As shown in block 801, the formula or set of formulas that collectively describe how a price will be determined for the purposes of the bid is determined. The system stores each such formula in the bid evaluation formula set depicted in FIG. 1. Then, for each variable in each formula in the bid evaluation formula set, the system queries the buyer as to whether the variable is a specification supplied by the buyer (a “specification variable”) or a value to be supplied by the bidder (a “pricing variable”), in block 802.

In block 803, for each specification variable, the variable name, data type, and unit of measure (“UOM”) for that variable are determined. The data type can take a variety of forms, but it is more commonly an integer, a real number, an array, a table, a list having a finite number of values, or a Boolean variable (a special case of a list variable where the values are either zero or one). The system stores these answers in the variable matrix data structure depicted in FIG. 2.

In block 804, for each pricing variable, the variable name, data type, and unit of measure (“UOM”) for that variable are determined. Pricing variables are also most commonly an integer, a real number, an array, a table, a list having a finite number of values, or a Boolean variable (a special case of a list variable where the values are either zero or one). The system stores these answers in the variable matrix data structure depicted in FIG. 2.

In block 805, the system executes a computability check on the variables and formulas (information collected in block 801, block 802, block 803, and block 804). In some cases, it is possible that the set of formulas entered by the user is not, in fact, computable. This issue could easily come up in the multiple formula case. For example, imagine that there are 3 equations F1, F2, and F3. The final item price then needs to be some computable combination of those formulas, most commonly:

item price=F1+F2+F3.

But it is likely that there will be cases where the user attempts to use a variable that has not been defined, or cases where the user supplies the equations for calculating intermediate subtotals like F1, F2, and F3, but forgets to tell the system how to combine F1, F2, and F3 together to determine the final item price. For example, there are cases where intermediate subtotals F2 and F3 are negative adjustments to price, and so the final item price formula should be:

item price=F1−F2−F3

The computability check step traps these basic errors and provides the user with an opportunity to correct the formulas. If the sets of formulas, variables, and units of measure fail the computability check, then the system moves to block 806 to allow the buyer to repair the error(s). If the sets of formulas, variables, and units of measure pass the computability check, the system moves to block 807 and continues processing the data structures and, optionally, the price improvement process. Note that there are M specification variables and P pricing variables in the bid evaluation formula set, so there would be M+P rows in the variable matrix data structure, one for each unique variable in the bid evaluation formula set.

In block 806, the system allows the buyer to revise the formulas, variables, data types, and unis of measure. The system then re-runs the computability check of block 805. In block 807, the system creates the specification variable matrix (see FIG. 3.) and pricing variable matrix (see FIG. 4) from the information collected and stored in the variable matrix data structure.

In block 808, the system uploads other static documents and forms associated with the bid by searching one or more databases for the documents relevant to the bid. These documents may include legal terms and conditions that would apply to any bidder choosing to participate in the bidding event, bidding rules that apply to any bidder choosing to supply bids during the bid event, and question-and-answer type forms. In some embodiments, the system may query the buyer to upload their responses to some of the documents and forms associated with the bid event.

In block 809, the system displays the specification variables their data types and units of measure, the pricing variables their data types and units of measure, the bid evaluation formula set, the static documents, and the forms (collectively, the “Bid Design”) to the buyer. The system then automatically reviews (e.g., based on predetermined rules, prediction and/or heuristics for the bid event) and allows the buyer to review each element of the bid design and make adjustments as necessary (block 811) until satisfied (block 810).

FIG. 9 depicts an exemplary process for populating the specification variable matrix, according to some embodiments of the disclosure. The system queries the buyer to upload the scenario file and saves this information into a temporary location in the system memory, in block 901. In some embodiments, the scenario file is a set of historical transactions, or items related to the bidder and/or the bid event, however, the buyer may choose to populate the scenario file with transactions that reflect a pro-forma projection of future demand, benchmark transactions available to the buyer, or any set or subset of transactions that the buyer finds interesting and chooses to evaluate.

Some example scenarios that the system or the buyers might choose to evaluate are as follows: (i) the items could reflect the entire historical spending for each stock keeping unit that was procured over the last year for the procurement category at hand, (ii) the items could reflect proposed future spending due to a new product or service, (iii) the items could reflect model transactions that had been previously benchmarked by a third party benchmarking service, or (iv) the items could reflect a particular segment where the buyer has uncovered new sources of supply and wants to test new suppliers out against established sources of supply in that segment. Traditionally, the items in the scenario file are referred to as the “baseline”, but the baseline may be not only an historical spending pattern but also a ‘pro-forma’ or projected spending plan that has not occurred yet.

In block 901, the system then parses the scenario file and identifies the historical or benchmark price paid for each transaction or queries the buyer to identify the historical or benchmark pricing information (block 903), if available (block 902). Note that historical pricing for any pro-forma transactions is not likely to be available in the scenario file. In block 904, the system continues parsing the scenario file information and identifies (or queries the buyer to identify) the item weightings and specification variables that are applicable to each transaction in the scenario file.

In block 305, the system populates the specification variable matrix using the information from the variable matrix, the scenario file, and the information collected from blocks 902, 903, and 904. In some embodiments, the data in the scenario file is organized into columns, or vector data structures. The system then associates each specification variable with the vector corresponding to that specification variable in the scenario file. The output of block 905 is a tentative specification variable matrix, which is retrieved from memory and displayed to the buyer in block 906. In block 907, the system reviews or allows the buyer to review the items and specification variables comprising the specification variable matrix and to adjust them until satisfied, in block 908. The buyer then inputs to the system that the buyer is satisfied with the tentative specification variable matrix, or the system determines that the tentative specification variable matrix meets a certain predetermined standard, in block 909. The system then marks the tentative specification variable matrix as the approved specification variable matrix.

FIG. 10 depicts an exemplary process for collecting bids from suppliers, according to some embodiments of the disclosure. In block 1001, the system identifies suppliers' contact information for those suppliers who are to be invited to the bid. In block 1002, the system computes and then transmits or publishes, for example on a website, the bid template, which includes the bid design (e.g., from block 807 of FIG. 8) plus the approved specification variable matrix from block 909 less any historical or benchmark price paid information. In block 1003, the system then retrieves the elements of the bid template from the stored data structures, transmits them to the identified suppliers, and electronically notifies the suppliers accordingly in block 1004.

In block 1005, the suppliers then prepare their responses and upload their answers to the system, for example, via a website and/or a graphical user interface (GUI) in block 1006. Each supplier may have predetermined responses and answers associated with categories of bid events and/or categories of buyers that the system can automatically retrieve from a database. In block 1007, the system receives and stores each supplier's responses. The system stores the pricing variables within each supplier's response in the pricing variable matrix. Individual item prices are then computed in the next step below. In some embodiments, the supplier response may also include completed question and answer forms.

FIG. 11 shows an exemplary process for a bid evaluation, according to some embodiments of the disclosure. As shown in block 1101, the system applies the bid evaluation formula set using the observations in the specification variable matrix and pricing variables in the pricing variable matrix to compute supplier bid prices by item. The system stores these item-level prices for each bidding supplier in the bid evaluation matrix. Note that the size of the matrix containing the set of calculated prices is N×S where N is the number of items in the specification variable matrix and S is the number of bidding suppliers. For example, if there were 50 items in the specification variable matrix, and 20 bidding suppliers, the system would compute 50×20 or 1,000 item prices and store them in the bid evaluation matrix.

In block 1102, if the specification variable matrix contains the optional historical or benchmark paid price information, then the system copies that information into the bid evaluation matrix and computes the projected savings attributable for each transaction across all bidding suppliers (block 1103). The system stores all item-level pricing and savings calculation results in the bid evaluation matrix. In block 1104, the system calculates a pre-programmed set of analyses that support decisions regarding negotiations and supplier choice.

In some embodiments, the pre-programmed analyses are a set of canned reports. Canned reports are a common feature known in the art and used across a wide variety of domains (examples: business intelligence tools, data visualization tools). The system displays these analyses and may produce printed reports of same in block 1105. In some embodiments, the reports compare not only the individual item prices in the bid evaluation matrix but also the descriptive statistics for the pricing variables provided by the suppliers and stored in the pricing variable matrix. Observe that it is the variances in the supplier bids stored in the pricing variable matrix (i.e., variances in the values of the pricing variables that were solicited during the bid) that drive variances in final item prices stored in the bid evaluation matrix.

FIG. 12 depicts an exemplary process for price improvement, according to some embodiments of the disclosure. As shown in block 1201, the system queries the buyer (e.g., from a website or pull-down menu) to choose an initial set of bids to use as proxy target prices for the price improvement process. In block 1202, the system displays the proxy target prices to the buyer. Note that the proxy target prices are the pricing variable dimensions from the bid, not the individual item prices for the transactions in the bid evaluation matrix. In block 1203, the system queries the buyer to determine whether to continue with the selected set of proxy target prices, or to optionally refine them further.

If the buyer chooses to further refine the proxy target prices, then in block 1204 the system queries (e.g., from a website or pull-down menu) the buyer for a formula to use for revising the proxy target prices. In some embodiments, the system selects the formula to use for revising the proxy target prices automatically based on predetermined data, such as historical data, buyer profile, and/or supplier profile. An example of a common formula to be selected is to have the system compute the synthetic minimum price across all the bidding suppliers for each pricing variable in the bid. The computed synthetic minimum bid can be thought of as the price level that traces out the shape of the least cost pricing manifold for the procurement domain at hand using the pricing information collected during the bid. The system may store the pricing variables for any number of synthetic (i.e., computed) suppliers in the pricing variable matrix. In this way, the values for any number of synthetic suppliers can be saved and readily compared to the actual bidding suppliers due to the design of the pricing variable matrix.

The buyer or the system may also choose to generate any number of additional sets of synthetically generated target prices at this stage, such as the synthetic minimum price plus or minus a numerical percentage, and the like. The system saves these additional sets of the computationally generated target prices as additional synthetic suppliers in the pricing variable matrix. The system also applies the bid evaluation formula set using the items of the specification variable matrix and the pricing variables for the synthetic suppliers, storing the results in the target pricing matrix. In an optional block 1205, the system queries the buyer as to whether the buyer desires to adjust individual prices resulting from the calculations in the last step. Some procurement domains have intrinsic trade-off decisions between different pricing variables, and this step allows the buyer to make those trade-off decisions. The system accepts any manual entries provided by the buyer during this step. The system stores the revised pricing variables generated by this step in the pricing variable matrix across from the appropriate synthetic supplier. The system then recomputes and stores the item prices in the target pricing matrix data structure, using the revised pricing variables. The outcome of this step is a pricing variable matrix data structure populated with the pricing variables for all of the bidding suppliers and any number of synthetic suppliers and a target pricing matrix containing the item prices and projected savings associated with the synthetic suppliers.

In block 1206, the system modifies the bid template by appending the target prices for one or more synthetic suppliers to the bid template. In block 1207, the system re-executes the collect bids process (a process that is similar to the process of block 703) with the revised bid template. The output at this stage is an updated pricing variable matrix from each bidding supplier that may contain improved pricing variable values that are closer to the synthetic supplier values. The price improvement process provides feedback to the suppliers who initially provided bids. The suppliers then compare the values that they initially submitted to the synthetic supplier prices coming back in this additional round of bidding. This type of detailed feedback tends to encourage the bidding suppliers to improve (i.e., lower) their prices.

In block 1208, the system also re-executes the bid evaluation process (a process that is identical to the bid evaluation process in block 704) with the new supplier bids. The output at this stage is a revised bid evaluation matrix.

If it is determined that the results of the price improvement process are unsatisfactory (block 1209), the system displays the proxy target prices for each pricing variable to the buyer (block 1210) and re-executes the processes that set proxy target prices, collect bids, and perform bid evaluation. A buyer that has completed the price discovery and price improvement process of FIGS. 7 to 12 is now in a position to realize the fruits of their labor with a pricing vector quoting machine.

FIGS. 13 through 17 illustrate the data structures for the pricing vector quoting machine, and FIG. 18 illustrates the process used by the quoting machine itself. A quick survey of these figures reveals that these data structures are similar to the data structures described in FIGS. 1 through 6, but the timing, method of use, and values are different. If a buyer has achieved satisfactory results from the price discovery and price improvement processes described herein, the buyer will likely desire to create contracts with one or more of the successful bidders. Once such contracts are agreed to between a buyer and one or more suppliers, the buyer can use the data structures of FIGS. 13 to 17 to implement a special purpose quoting machine that can electronically compute prices for all items in the procurement category across all contracted suppliers in that category.

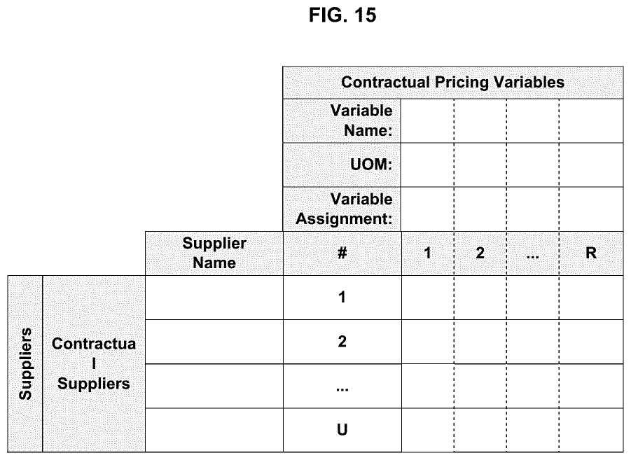

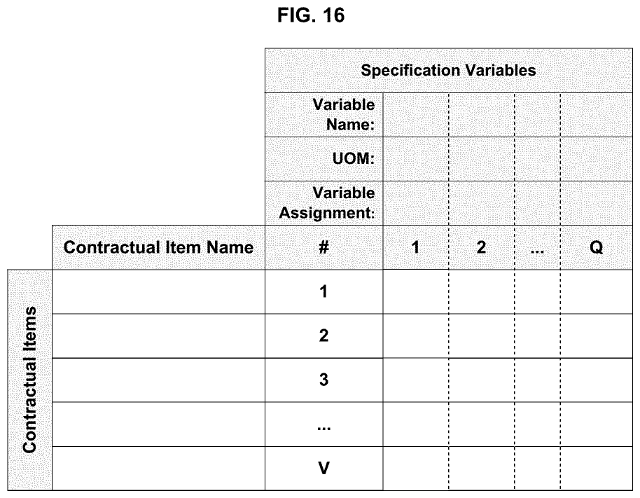

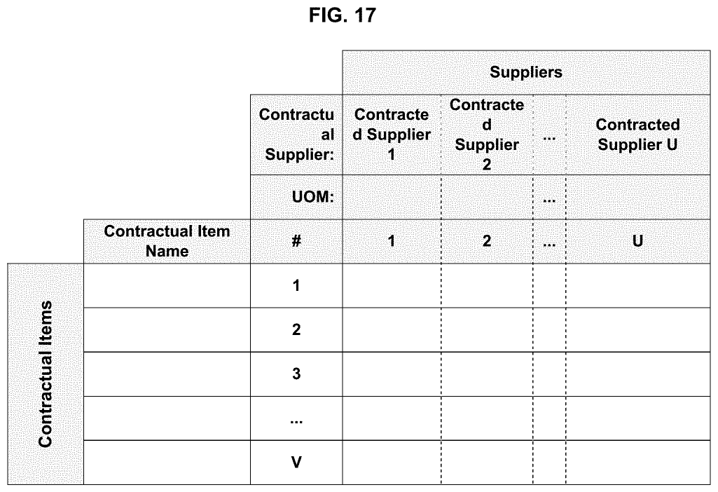

The utility of such a quoting machine is that a buyer no longer needs to conduct individual bids when presented with specifications for a new item in that category. The buyer simply enters the specifications into the contractual item specification matrix of FIG. 16 and the quoting machine, having been previously loaded with the contractual formulas (FIG. 13), contractual variables (FIG. 14), and the pricing variables agreed to with each supplier (FIG. 15), returns the set (or vector) of the contractual item prices for all suppliers defined to the machine (FIG. 17). Thousands or tens of thousands of historical items may be defined for such a quoting machine (by populating the contractual item variables matrix of FIG. 16 with the item specification variables for each historical item). Then, the quoting machine can pre-determine the alternative prices for those historical items across an entire set of prospective suppliers.

FIG. 13 illustrates the contractual formula set, a data structure that stores 1-G formulas using 1-Q specification variables and 1-R pricing variables for the pricing vector quoting machine. This data structure is similar to the bid evaluation formula set; however, the bid evaluation formula set and the matrixes of FIG. 13 are populated at different times. The bid evaluation formula set is populated before the bidding event, whereas FIG. 13 is populated after the conclusion of the bidding event if the buyer and supplier are able to come to a contractual agreement on the pricing formulas and values.

FIG. 14 Illustrates the contractual variables matrix, a data structure for capturing the essential variable relationships; namely, the variable assignment, variable name, data type, unit of measure, and type of variable (specification variable or pricing variable) for the pricing vector quoting machine. FIG. 14 is similar to FIG. 2, but they are populated at different times. FIG. 2 is populated before the bidding event, whereas FIG. 14 is populated after the conclusion of the bidding event if the buyer and supplier are able to come to a contractual agreement on the pricing formulas and values.

FIG. 15 illustrates a contractual pricing variable matrix, a data structure for storing the 1-R pricing variables for 1-U suppliers for the pricing vector quoting machine. This data structure is similar to the pricing variable matrix of FIG. 4; however, FIG. 4 and FIG. 15 are populated at different times. FIG. 4 is populated during the bidding event, whereas FIG. 15 is populated after the conclusion of the bidding event if the buyer and supplier are able to come to a contractual agreement on the values of the individual pricing variables. Each row of the matrix represents an individual contract between a buyer and a specific supplier. In some embodiments, the contracts are smart contracts executed on a Blockchain platform that self-execute when their conditions are met.

FIG. 16 illustrates the contractual item variables matrix, a data structure that stores 1-Q specification variables for 1-V individual items for the pricing vector quoting machine. This data structure is similar to the specification variable matrix of FIG. 3; however, FIG. 3 and FIG. 16 are populated at different times. FIG. 3 is populated before the bidding event, whereas FIG. 16 is populated after the conclusion of the bidding event if the buyer and supplier are able to come to a contractual agreement on a set of pricing formulas and values. Assuming that the buyer and supplier are able to come to such a contractual agreement, the data structure of FIG. 16 is populated with the specification variable for any number of items. In the simplest case, the buyer can populate just one row of this matrix and then use the calculation method of the present disclosure (block 1101 of FIG. 11) to compute the contractual price for that one item.

FIG. 17 illustrates the contractual item pricing matrix, a data structure that stores the pricing for 1-V individual items for 1-U suppliers. This data structure is similar to the bid evaluation matrix of FIG. 6; however, FIG. 6 and FIG. 17 are populated at different times. FIG. 6 is populated during the bidding event, whereas FIG. 17 is populated after the conclusion of the bidding event if the buyer and supplier are able to come to a contractual agreement on a set of pricing formulas and values. Assuming that the buyer and supplier and are able to come to such a contractual agreement, and further assuming the buyer has populated FIG. 16 with the specification variables for any number of items, then the system can calculate and store the contractual pricing for an arbitrary number of items stored in the data structure of FIG. 16 for every contracted supplier in FIG. 17.

FIG. 18 illustrates a process for creating a pricing vector quoting machine, a computer-implemented method for pricing individual items which uses the data structures of FIG. 13, FIG. 14, FIG. 15, FIG. 16, and FIG. 17. As shown in block 1801, contracting with suppliers, the buyer arrives at contracts with a set of suppliers that take the form of a set formulas and variables that are intended to be used by the pricing procedure described herein. A buyer might use the methods of price discovery and price improvement of the present disclosure prior to establishing these contracts but is not required to do so.

In block 1802, the buyer loads the contractual formula set (FIG. 13) with 1-G formulas using 1-Q specification variables and 1-R pricing variables. In block 1803, the contractual variable matrix (FIG. 14) is loaded with Q+R variables and their associated variable names, data types, units of measure, and variable types (i.e., specification variable or pricing variable). In block 1804, the contractual pricing variable matrix (FIG. 15) is loaded with the 1-R pricing variables and the values for 1-U suppliers that reflect the contractual pricing for each supplier.

In block 1805, the contractual item specification variable matrix (FIG. 16) is loaded with the specification variables reflecting at least one item. In block 1806, the item prices are computed for 1-U suppliers and 1-V items using the formulas stored in the contractual formula set data structure of FIG. 13, the pricing variables and specification variables stored in the variables matrix data structure of FIG. 14, the pricing variables stored in the contractual pricing variable matrix data structure of FIG. 15, and the specification variables stored in the contractual item specification variable matrix data structure of FIG. 16. The resulting item prices are then stored in the contractual item pricing matrix data structure of FIG. 17. In block 1807, the system displays the contents stored in the contractual item pricing matrix data structure to the buyer.

### Use Case

The following is a use case example of the system and method of the present disclosure. A bid evaluation formula set that allows for item prices to be computed by the system is created by the system or by the buyer and distinguished between specification variables and pricing variables consistent with the item pricing formulas. A bidding event that requests bids for pricing variables is then designed subject to the specification variables and the bid evaluation formula set. To keep things simple for this example, the bid evaluation formula set consists of one formula as follows:

$$Item Price = π L ( \frac{{D}_{O}^{2} - {D}_{I}^{2}}{4} ) \times Y \times ( P v + CoPg + E x ) + C n C u + PaPr$$

In some embodiments, the bid evaluation formula set could have alternatively been supplied as three individual formulas, each computing an intermediate result, and then a fourth formula that sums together the three intermediate results. In a more general case, the bid evaluation formula set may be expressed as any number of formulas with any number of specification variables and pricing variables selected by the system and/or by the buyer. The system then queries the buyer to segregate the specification variables from the pricing variables contained within the bid evaluation formula set. For our example, the formula has the following specification variables:
D_{O} Outside Diameter—the cross-sectional length of a line that extends from one outer edge of the pipe to the other outer edge of the pipe where that line passes through the center of the pipe.
D_{I}—Inside Diameter—the cross-sectional length of a line that extends from one inner edge of the pipe to the other inner edge of the pipe where that line passes through the center of the pipe.
L—Length—the end-to-end measurement of the pipe
Cn—Number of Cuts—number of cuts needed to shorten the pipe to its desired length.
Co—A dichotomous variable capturing the color of the pipe, 0 if the color of PVC pipe is white or gray, 1 otherwise.
Pa—Print Area—the area allocated for imprinting logos, specifications, and other text onto the pipe.
Y—Density—the ratio of weight to volume for a certain substance, in this case, PVC. A constant.

The system receives the data types and their respective units of measure for the specification variables, and for this example those data types are as follows: D_{O}, D_{I}, L, Pa, and Y are real numbers, Cn is an integer, and Co is a Boolean variable. For our example, the formula has the following pricing variables and units of measure:

| | |
|---|---|
| Pv—PVC pellets bid per unit of weight | ($/lb.) |
| Pg—Pigment bid per unit of weight to color | ($/lb.) |
| PVC pipe. | |
| Ex—Extrusion bid per unit of weight, | ($/lb.) |
| Cu—Cutting bid | ($/cut) |
| Pr—Printing bid | ($/sq inch of print area) |

Once the system has collected the bid evaluation formula set, identified the specification variables their data types and their units of measure, and identified the pricing variables their data types and units of measure, the system determines whether the system of formulas and variables taken as a whole is computable. In some embodiments, the system computes whether or not the set of formulas and variables is, in fact, computable. If there is an incomputable bid design, the system would flag that error for the user. In the event an error is detected, the system then displays all of the components to the user for editing and re-submission.

Note that in this particular example, the disclosed approach permits a buyer to execute a bidding event having a bid design consisting of 7 specification variables, 5 pricing variables, and one formula. Each supplier only needs to supply 5 pricing variables during the bidding event itself. Yet, after collecting just 5 pricing variables from the participating bidders during a bidding event, the scope of the bid design is sufficient to allow the buyer to compute supplier prices for an infinite number of PVC pipe specifications.

The system then uploads the scenario file. The scenario file is most commonly a set of historical transactions, but the buyer can choose to populate the scenario file with transactions that reflect a pro-forma projection of future demand (e.g., items that correspond to a new product launch contemplated in the near future) or any set of transactions that the buyer finds interesting and chooses to evaluate. In some embodiments, it is possible for the buyer to provide the system with the scenario file information through an interactive dialogue. However, as real-world scenario files can potentially contain thousands of items, the scenario file information will most commonly be provided to the system in the form of a data file upload. An example of a scenario file for this example is depicted in Table 1.

TABLE 1
Scenario File

| | | Variable | | | | | | | |
|---|---|---|---|---|---|---|---|---|---|
| | | Name | Specification Variables | | | | | | |
| | Historical | UOM | Outside | Diameter | | | # of | | Print |
| | Price | Variable | Diameter | Inside | Length | Density | Cuts | Color | Area |
| Weight | Paid | Assignment | in | in | in | lbs./ft³ | # | # | in² |
| % | $/unit | # | 1 | 2 | 3 | 4 | 5 | 6 | 7 |
| 8.333 | 104.50 | 1 | 10.75 | 9.976 | 120 | 87.40 | 4 | 1 | 5 |
| 8.333 | 3.05 | 2 | 1.315 | 1.029 | 120 | 87.40 | 1 | 0 | — |
| 8.333 | 24.00 | 3 | 8.625 | 7.942 | 60 | 87.40 | 1 | 0 | — |
| 8.333 | 74.30 | 4 | 8.625 | 7.565 | 120 | 87.40 | 2 | 0 | 7.28 |
| 8.333 | 122.35 | 5 | 6.625 | 5.709 | 240 | 87.40 | 2 | 1 | 25.58 |
| 8.333 | 9.23 | 6 | 1.900 | 1.590 | 180 | 87.40 | 1 | 1 | — |
| 8.333 | 17.85 | 7 | 3.500 | 2.864 | 120 | 87.40 | 1 | 0 | — |
| 8.333 | 2.34 | 8 | 1.660 | 1.360 | 60 | 87.40 | 4 | 0 | 11 |
| 8.333 | 0.95 | 9 | 0.675 | 0.407 | 60 | 87.40 | 4 | 1 | — |
| 8.333 | 5.27 | 10 | 1.900 | 1.590 | 120 | 87.40 | 1 | 0 | 8.44 |
| 8.333 | 2.46 | 11 | 1.660 | 1.360 | 60 | 87.40 | 1 | 0 | — |
| 8.333 | 1.98 | 12 | 0.540 | 0.288 | 240 | 87.40 | 2 | 0 | — |

The system stores the uploaded scenario file in a temporary location, however at this point, the system does not know which column of information to associate with each specification variable in the bid evaluation formula set. That is, immediately after uploading the scenario file, the system does not know how to complete the row labeled “Variable Assignment” in the specification variable matrix. In some embodiments, the system then engages the buyer in a dialogue to assign each specification variable in the bid evaluation formula set to a particular column of data in the uploaded scenario file. In some embodiments, the system may suggest to the buyer what specification variables need to be assigned in the bid evaluation formula set.

The system then records the specification variable assignments by populating the variable assignment field in the specification variable matrix, and it loads the remaining rows of the scenario file into the specification variable matrix. An example of part of the specification variable matrix showing the variable assignments is shown in Table 2 below.

TABLE 2
Variable Assignments in the Specification Variable Matrix

| | | | Specification Variables | | | | | | |
|---|---|---|---|---|---|---|---|---|---|
| | Historical | Variable | Outside | Inside | | | # of | | Print |
| Weight | Price Paid | Name | Diameter | Diameter | Length | Density | Cuts | Color | Area |
| % | $/unit | UOM | in | in | in | lbs./ft³ | # | # | in² |
| W | H | Variable | D_{O} | D_{I} | L | Y | Cn | Co | Pa |
| | | Assignment | | | | | | | |

The output of this step is a fully populated specification variable matrix. To summarize, there are two differences between the specification variable matrix and the scenario file: (1) the fully populated specification variable matrix is a data structure ready to be used in further computations, whereas the scenario file is just a file of data; and (2) the specification variable matrix has variable assignments consistent with the variables used in the bid evaluation formula set and the scenario file does not. An example of the specification variable matrix is shown in Table 3 below.

TABLE 3
Specification Variable Matrix

| | | Variable | Specification Variables | | | | | | |
|---|---|---|---|---|---|---|---|---|---|
| | Historical | Name | Outside | Diameter | | | # of | | Print |
| % | Price | UOM | Diameter | Inside | Length | Density | Cuts | Color | Area |
| weight | Paid | Variable | in | in | in | lbs./ft³ | # | # | in² |
| % | $/unit | Assignment | D_{O} | D_{I} | L | Y | Cn | Co | Pa |
| W | H | # | 1 | 2 | 3 | 4 | 5 | 6 | 7 |
| 8.333 | 104.50 | 1 | 10.75 | 9.976 | 120 | 87.40 | 4 | 1 | 5 |
| 8.333 | 3.05 | 2 | 1.315 | 1.029 | 120 | 87.40 | 1 | 0 | — |
| 8.333 | 24.00 | 3 | 8.625 | 7.942 | 60 | 87.40 | 1 | 0 | — |
| 8.333 | 74.30 | 4 | 8.625 | 7.565 | 120 | 87.40 | 2 | 0 | 7.28 |
| 8.333 | 122.35 | 5 | 6.625 | 5.709 | 240 | 87.40 | 2 | 1 | 25.58 |
| 8.333 | 9.23 | 6 | 1.900 | 1.590 | 180 | 87.40 | 1 | 1 | — |
| 8.333 | 17.85 | 7 | 3.500 | 2.864 | 120 | 87.40 | 1 | 0 | — |
| 8.333 | 2.34 | 8 | 1.660 | 1.360 | 60 | 87.40 | 4 | 0 | 11 |
| 8.333 | 0.95 | 9 | 0.675 | 0.407 | 60 | 87.40 | 4 | 1 | — |
| 8.333 | 5.27 | 10 | 1.900 | 1.590 | 120 | 87.40 | 1 | 0 | 8.44 |
| 8.333 | 2.46 | 11 | 1.660 | 1.360 | 60 | 87.40 | 1 | 0 | — |
| 8.333 | 1.98 | 12 | 0.540 | 0.288 | 240 | 87.40 | 2 | 0 | — |

The system then publishes the bid, collects bids from the participating suppliers, and stores the pricing collected from the suppliers in the pricing variable matrix data structure, an example of which is shown in Table 4 below.

TABLE 4
Supplier Bids Stored in the Pricing Variable Matrix

| | | Variable | Pricing Variables | | | | |
|---|---|---|---|---|---|---|---|
| | | Name | PVC | | | | |
| | | UOM | Pellets | Pigment | Extrusion | Cutting | Printing |
| | | Variable | $ per lb. | $ per lb. | $ per lb. | $ per cut | $ per sq. ft. |
| | Supplier | Assignment | Pv | Pg | Ex | Cu | Pr |
| Suppliers | Name | # | 1 | 2 | 3 | 4 | 5 |

| | | | | | | |
|---|---|---|---|---|---|---|
| Bidding | Supplier A | 0.80 | 0.15 | 0.15 | 0.08 | 0.05 |
| Suppliers | Supplier B | 0.75 | 0.25 | 0.15 | 0.05 | 0.01 |
| | Supplier C | 0.70 | 0.25 | 0.20 | 0.03 | 0.03 |
| Synthetic | Synthetic | | | | | |
| Suppliers | Minimum | | | | | |

In block 501 of FIG. 11, the system uses the specifications in the specification variable matrix, the supplier pricing stored in the pricing variable matrix, and the formulas in the bid evaluation formula set to compute the item prices for each item in the specification variable matrix and stores the computed item-level prices in the bid evaluation matrix data structure (FIG. 5). In this use case example, the bid evaluation formula set contains one formula. Applying this formula to item 1 in the specification variable matrix using the pricing variables received from supplier A, the system computes Supplier A's bid price for item 1 to be as follows:

$${Bid}_{A 1} = π L ( \frac{{D}_{O}^{2} - {D}_{I}^{2}}{4} ) \times Y \times ( P v + CoPg + E x ) + C n C u + PaPr$$

$$where ,$$

$${Bid}_{A 1} = \frac{120 π ( \frac{{10.75}^{2} - 9.97 {6}^{2}}{4} )}{1728} \times 87.4 \times ( 0.8 + ( 1 ) ( 0.15 ) + 0.15 ) + ( 4 ) ( 0.08 ) + ( 5 ) ( 0.05 )$$

Note that the specification variable matrix and the pricing variable matrix provide for the units of measure associated with each variable. With this information, the system is able to perform unit conversion mathematics. In this use case example, the system divides volume by 1,728 to convert from cubic inches to cubic feet. The system then computes supplier A's bid for item 1 as follows:

Bid_{A1}=0.875×87.4×1.1+0.32+0.25

Bid_{A1}=84.69

The system then repeats the calculation process for each supplier's bid across all of the items in the specification variable matrix, storing the results in the bid evaluation matrix. Note that in this use case example, the specification variable matrix is also populated with historical price paid information for each item. When the optional historical price paid information is present, the system computes the current bid results calculation showing savings versus historical prices paid and stores the results in the bid evaluation matrix of FIG. 5; example shown in Table 5 below.

TABLE 5
Bid Evaluation Matrix

| | | Variable | | | | | | | | | | | | |
|---|---|---|---|---|---|---|---|---|---|---|---|---|---|---|
| | | Name | | | | | | | | | | | | |
| | | Unit of | Supplier A | | | Supplier B | | | Supplier C | | | | | |
| % | Historical | Measure | Bid | | | Bid | | | Bid | | | | | |
| Weight | Price Paid | Variable | Price | Savings | Savings | Price | Savings | Savings | Price | Savings | Savings | | Savings | Savings |
| % | $/unit | Assignment | $ | $ | % | $ | $ | % | $ | $ | % | | $ | % |
| W | H | # | $/unit | $/unit | % | $/unit | $/unit | % | $/unit | $/unit | % | Winner | $/unit | % |
| 8.333 | $104.50 | 1 | $84.69 | $19.81 | 19% | $88.19 | $16.31 | 16% | $88.21 | $16.29 | 16% | A | $19.81 | 19% |
| 8.333 | $3.05 | 2 | $3.12 | ($0.07) | −2% | $2.93 | $0.12 | 4% | $2.91 | $0.14 | 5% | C | $0.14 | 4% |
| 8.333 | $24.00 | 3 | $25.70 | ($1.70) | −7% | $24.32 | ($0.32) | −1% | $24.30 | ($0.30) | −1% | C | ($0.30) | −1% |
| 8.333 | $74.30 | 4 | $78.24 | ($3.94) | −5% | $73.80 | $0.50 | 1% | $73.90 | $0.40 | 1% | B | $0.50 | 1% |
| 8.333 | $122.35 | 5 | $119.92 | $2.43 | 2% | $124.22 | ($1.87) | −2% | $124.70 | ($2.35) | −2% | A | $2.43 | 2% |
| 8.333 | $9.23 | 6 | $8.59 | $0.64 | 7% | $8.95 | $0.28 | 3% | $8.93 | $0.30 | 3% | A | $0.64 | 7% |
| 8.333 | $17.85 | 7 | $18.41 | ($0.56) | −3% | $17.41 | $0.44 | 2% | $17.39 | $0.46 | 3% | C | $0.46 | 3% |
| 8.333 | $2.34 | 8 | $2.92 | ($0.58) | −25% | $2.25 | $0.09 | 4% | $2.39 | ($0.05) | −2% | B | $0.09 | 4% |
| 8.333 | $0.95 | 9 | $1.08 | ($0.13) | −14% | $0.99 | ($0.04) | −4% | $0.91 | $0.04 | 4% | C | $0.04 | 4% |
| 8.333 | $5.27 | 10 | $5.40 | ($0.13) | −2% | $4.78 | $0.49 | 9% | $4.92 | $0.35 | 7% | B | $0.49 | 9% |
| 8.333 | $2.46 | 11 | $2.13 | $0.33 | 13% | $1.99 | $0.47 | 19% | $1.97 | $0.49 | 20% | C | $0.49 | 20% |
| 8.333 | $1.98 | 12 | $2.05 | ($0.07) | −4% | $1.89 | $0.09 | 5% | $1.85 | $0.13 | 7% | C | $0.13 | 7% |

Assuming that the bidding event rules allow for price improvement, the system executes price improvement as follows. The system asks the buyer for an initial set of bids upon which to base proxy target prices. The system displays those prices and asks whether the buyer is satisfied with those prices. The proxy target prices may be further adjusted by providing a formula such as the synthetic minimum across all the supplier bids received, the synthetic minimum plus or minus a percentage amount, or individually adjusting the target prices. Assume that the buyer selects (e.g., from a pull-down menu of options populated by the system) the synthetic minimum price for each pricing variable across all of the participating suppliers as the target price. This selection results in the system computing the synthetic minimum target prices and populating the last row of the pricing variable matrix data structure with those calculation results:

TABLE 6
Populating Synthetic Supplier Pricing Variables in the Pricing Variable Matrix

| | | Variable | Pricing Variables | | | | |
|---|---|---|---|---|---|---|---|
| | | Name | PVC | | | | |
| | | UOM | Pellets | Pigment | Extrusion | Cutting | Printing |
| | | Variable | $ per lb. | $ per lb. | $ per lb. | $ per cut | $ per sq. ft. |
| | Supplier | Assignment | Pv | Pg | Ex | Cu | Pr |
| Suppliers | Name | # | 1 | 2 | 3 | 4 | 5 |

| | | | | | | |
|---|---|---|---|---|---|---|
| Bidding | Supplier A | 0.80 | 0.15 | 0.15 | 0.08 | 0.05 |
| Suppliers | Supplier B | 0.75 | 0.25 | 0.15 | 0.05 | 0.01 |
| | Supplier C | 0.70 | 0.25 | 0.20 | 0.03 | 0.03 |
| Synthetic | Synthetic | 0.70 | 0.15 | 0.15 | 0.03 | 0.01 |
| Suppliers | Minimum | | | | | |

At this point, the system is also able to compute the implied item prices and projected savings that would result if a supplier were willing to meet the synthetic minimum target prices given that the specification variables, the items in the specifications variable matrix, and the formulas in the bid evaluation formula set have already been established. The system allows the buyer to engage in an interactive target price setting dialogue to further adjust the target prices, if applicable. For the target prices selected above, the system stores the target prices in the pricing variable matrix data structure and computes the corresponding item prices, which it stores in the target pricing matrix (FIG. 6), depicted in Table 7 below.

TABLE 7
Populating the Target Pricing Matrix

| | | | Variable | | | |
|---|---|---|---|---|---|---|
| | | | Name | | | |
| | | | Unit of | Synthetic Supplier 1: | | |
| | % | Historical | Measure | Synthetic Minimum | | |
| | Weight | Price Paid | Variable | $/unit | $/unit | % |
| | % | $/unit | Assignment | Target | Savings | Savings |
| | W | H | # | Price | $ | % |
| items | 8.333 | $104.50 | 1 | $76.64 | $27.86 | 26.7% |
| | 8.333 | $3.05 | 2 | $2.75 | $0.30 | 10.0% |
| | 8.333 | $24.00 | 3 | $22.95 | $1.05 | 4.4% |
| | 8.333 | $74.30 | 4 | $69.67 | $4.63 | 6.2% |
| | 8.333 | $122.35 | 5 | $108.03 | $14.32 | 11.7% |
| | 8.333 | $9.23 | 6 | $7.77 | $1.46 | 15.9% |
| | 8.333 | $17.85 | 7 | $16.43 | $1.42 | 8.0% |
| | 8.333 | $2.34 | 8 | $2.07 | $0.27 | 11.7% |
| | 8.333 | $0.95 | 9 | $0.81 | $0.14 | 14.6% |
| | 8.333 | $5.27 | 10 | $4.50 | $0.77 | 14.6% |
| | 8.333 | $2.46 | 11 | $1.87 | $0.59 | 24.2% |
| | 8.333 | $1.98 | 12 | $1.75 | $0.23 | 11.6% |

When the buyer is satisfied with the proxy target prices, the system saves those proxy target prices as the target prices to be used in the price improvement steps below. In some embodiments, the system appends the target prices to the bid template and executes the collect bids process and the bid evaluation process using the revised bid template. The system may then display the results of the bidding round (by displaying an updated bid evaluation matrix as shown in Table 5) and producing printed reports detailing the results. When the buyer is satisfied with the results of the price improvement process, the system ends the price improvement execution.

The system and method of the present disclosure represents an advance over the conventional methods since:
i. The present disclosure has wider scope than the conventional methods, allowing the user to cover a broader set of specifications in one bidding event than the conventional methods would otherwise allow, and
ii. The present disclosure achieves its results using less time vs. the conventional methods, and
iii. The present disclosure generates superior sourcing results vs. the conventional methods.

The present disclosure uses less time than the tools of the conventional approaches because it replaces many small-lot bidding events found in the conventional methods with a single bidding event.

Additionally, the present disclosure generates superior sourcing results over the conventional methods since it transforms the low intensity pricing information environment of the conventional methods into a rich pricing information environment, which the buyer can exploit during the bidding event to generate superior sourcing outcomes that are unavailable to users of the low intensity pricing information tools in the conventional methods. Consider again the case of the buyer working with a finite set of items with known specifications and known quantities using the tools of the conventional methods. The pricing information generated by the tools of the conventional methods during a bidding event consists of a pair of coordinates (P, Q), where P represents price and Q represents quantity, for each item and for each participating supplier.

Tools known in the conventional methods plot these coordinates on a Cartesian coordinate grid for the buyer's review. The buyer's objective during the negotiation process is to improve upon those individual coordinate pairs, i.e., lower prices (P) at the same quantity level (Q) for each item and for each participating supplier. By contrast, the present disclosure provides the buyer with a view to the entire set of pricing curves, i.e., the plot of all prices P for all quantities Q for each participating supplier. More generally, the present disclosure also accommodates the three-dimensional case where the buyer's objective is to find the minima along a pricing surface that includes price, quantity, and a third independent variable relevant to that procurement domain.

The present disclosure also handles the arbitrarily complex general case of a procurement domain having price, quantity, and an arbitrary number of additional independent variables where the buyer's objective is to find pricing minima across a multi-dimensional pricing manifold. These kinds of problems are actually quite common in practice, and the PVC pipes use case example is but one such example. The present disclosure generates superior sourcing results over the conventional methods because it allows the buyer to negotiate the shape of the entire pricing manifold for the procurement domain across a set of suppliers all in one bidding event.

In some embodiments, the system utilizes six unique data structures for executing a process for improved price discovery and price improvement during a bidding event:
(a) a Bid Evaluation Formula Set described in FIG. 1;
(b) a Variable Matrix described in FIG. 2;
(c) a Specification Variable Matrix described in FIG. 3;
(d) a Pricing Variable Matrix described in FIG. 4;
(e) a Bid Evaluation Matrix described in FIG. 5; and
(f) a Target Pricing Matrix described in FIG. 6.

In some embodiments, the method for price discovery and price improvement during a price bidding event includes: creating a bid design as a set of specification variables, pricing variables, one or more bid evaluation scenarios, and one or more bid evaluation formulas; transmitting, over a computer network, the set of specification variables, pricing variables, one or more bid evaluation scenarios, and one or more bid evaluation formulas to potential bidders; receiving, over the computer network, a plurality of completed bids from the potential bidders through the computer system; and electronically evaluating the completed bids using the computer system. The process may further include providing the supplier with a supplier's perspective pro-forma bid estimator tool that implements the evaluation formulas of block 501 of FIG. 11 among the items comprising the bid. This tool may be used by suppliers to calibrate their pricing variable submission by using the specifications for any of the items included in the bid or any items they chose to specify on their own.

In some embodiments, the computer-implemented price improvement workflow includes six data structures for implementing the process for a pricing vector quoting machine, including:
(a) a Contractual Formula Set described in FIG. 13;
(b) a Contractual Variable Matrix described in FIG. 14;
(c) a Contractual Pricing Variable Matrix described in FIG. 15;
(d) a Contractual Item Specification Variable Matrix described in FIG. 16; and
(e) a Contractual Item Pricing Matrix described in FIG. 17.

The process executed by one or more processors may further include:
(a) loading the Contractual Formula Set (the data structure of FIG. 13) with 1-G formulas using 1-Q specification variables and 1-R pricing variables;
(b) loading the Contractual Variable Matrix (the data structure of FIG. 14) with Q+R variables and their associated variable names, data types, units of measure, and variable types (i.e., specification variable or pricing variable);
(c) loading the Contractual Pricing Variable Matrix (the data structure of FIG. 15) with the 1-R pricing variables and the values for 1-U suppliers that reflect pricing for each supplier;
(d) loading the Contractual Item Specification Variable Matrix (the data structure of FIG. 16) with the specification variables reflecting at least one item;
(e) computing the item prices for 1-U suppliers and 1-V items and storing them in a Contractual Item Pricing Matrix (the data structure of FIG. 17); and
(f) displaying the contents of the Contractual Item Pricing Matrix to the buyer.

It will be recognized by those skilled in the art that various modifications may be made to the illustrated and other embodiments of the disclosure described above, without departing from the broad inventive scope thereof. It will be understood therefore that the disclosure is not limited to the particular embodiments or arrangements disclosed, but is rather intended to cover any changes, adaptations or modifications which are within the scope of the disclosure as further defined by the claims and the drawings.

1. A computer implemented method of price discovery during a bidding event by a plurality of bidding suppliers, the method comprising:
creating a bid design file as a set of specification variables, pricing variables, one or more bid evaluation scenarios, and one or more bid evaluation formulas;
producing a scenario file as a set of observations based on historical transactions or projection of future demand or items related to the bidding suppliers or the price bidding event and respective weightings of each observation;
producing a data structure as a specification variable matrix including the bid scenario for each observation and item;
producing a data structure as a bid template including the pricing variables, bid evaluation formulas, and the specification variable matrix;
transmitting, over a computer network, the bid template to the bidding suppliers;
receiving, over the computer network, a plurality of completed bids from the bidding suppliers;
computing price savings attributable to each item across all bidding suppliers;
producing a data structure as a bid evaluation matrix including the computation of item bid prices for each bidder and for each item using the specification variables, and computed price savings attributable to each item across all bidding suppliers, wherein the bid evaluation matrix carries forward the item name and weightings and historical prices paid for each of the observations from the specification variable matrix, and wherein the bid evaluation matrix further includes information about bidding suppliers, from the pricing variable matrix; and
displaying, on a display screen, contents of the pricing variable matrix and bid evaluation matrix to a buyer, as the price discovery results for the plurality of bidding suppliers and items.

2. The method of claim 1, wherein the bid prices for each bidder for each item is computed by applying 1-F formulas using 1-M specification variables and 1-P pricing variables in the bid evaluation matrix, where F is number of formulas to be used, M is number of specification variables and P is number of pricing variables.

3. The method of claim 1, further comprising computing the projected savings attributable for each transaction across all bidding suppliers.

4. The method of claim 1, further comprising generating a report including comparison of individual item prices in the bid evaluation matrix and descriptive statistics for the pricing variables provided in a pricing variable matrix.

5. The method of claim 1, further comprising producing a data structure as a specification variables matrix for capturing 1-M specification variables for 1-N items, where M and N are integer numbers.

6. The method of claim 1, further comprising producing a data structure as a pricing variable matrix for capturing coefficients for 1-P pricing variables, 1-S bidding suppliers and 1-T synthetic suppliers, where S is number of bidding suppliers and T is number of synthetic suppliers, suppliers that represent acceptable benchmark pricing levels.

7. The method of claim 1, further comprising executing a computability check on the variables and formulas.

8. The method of claim 1, further comprising determining a variable name, data type, and unit of measure for each for each specification variable, wherein the data type may be an integer, a real number, an array, a table, a list having a finite number of values, or a Boolean variable, and storing the variable name, data type, and unit of measure in the variable matrix data structure.

9. The method of claim 1, wherein the bid template data structure further includes historical or benchmark pricing information for each observation in the scenario file.

10. The method of claim 1, wherein said computing price savings attributable utilizes pricing variables submitted by the bidding suppliers, the specifications and bid evaluation formulas in the bid template.
